(19) United States
(12) Patent Application Publication
(10) Pub. No.: US 2020/0241122 A1
(43) Pub. Date: Jul. 30, 2020

(54) RADAR SYSTEM WITH THREE-DIMENSIONAL BEAM SCANNING

(71) Applicant: Metawave Corporation, Carlsbad, CA (US)

(72) Inventors: Maha ACHOUR, Encinitas, CA (US); Safa Kanan Hadi SALMAN, Vista, CA (US); Raul Inocencio ALIDIO, Carlsbad, CA (US); Abdullah Ahsan ZAIDI, San Diego, CA (US)

(21) Appl. No.: 16/775,205

(22) Filed: Jan. 28, 2020

Related U.S. Application Data
(60) Provisional application No. 62/797,906, filed on Jan. 28, 2019.

(51) Int. Cl. G01S 13/42; H01Q 21/06; H01Q 3/04; G01S 13/931; G01S 13/46

(52) U.S. Cl. CPC G01S 13/426; H01Q 21/061; G01S 2013/468; G01S 13/931; G01S 2013/9316; H01Q 3/04

(57) ABSTRACT

Examples disclosed herein relate to a radar system for three-dimensional beam scanning that includes an antenna module that radiates radio frequency (RF) beams with an analog beamforming antenna in a plurality of directions using phase control elements and generates radar data capturing a surrounding environment from received RF return signals. The antenna module includes a first transceiver operational at a first frequency and configured to scan a field of view with first RF beams along a first axis, and a second transceiver operational at a second frequency and configured to scan the field of view with second RF beams along a second axis. The radar system also includes a perception module that detects and identifies a target in the surrounding environment from the radar data.

### CROSS-REFERENCE TO RELATED APPLICATIONS

This application claims priority from U.S. Provisional Application No. 62/797,906, titled “METHOD AND APPARATUS FOR 3D BEAMFORMING,” filed on Jan. 28, 2019, all of which are incorporated by reference herein.

### BACKGROUND

Autonomous driving is quickly moving from the realm of science fiction to becoming an achievable reality. Already in the market are Advanced-Driver Assistance Systems (ADAS) that automate, adapt and enhance vehicles for safety and better driving. The next step will be vehicles that increasingly assume control of driving functions such as steering, accelerating, braking and monitoring the surrounding environment and driving conditions to respond to events, such as changing lanes or speed when needed to avoid traffic, crossing pedestrians, animals, and so on. The requirements for object and image detection are critical and specify the time required to capture data, process it and turn it into action. All this while ensuring accuracy, consistency and cost optimization.

An aspect of making this work is the ability to detect and classify objects in the surrounding environment at the same or possibly at an even better level than humans. Humans are adept at recognizing and perceiving the world around them with an extremely complex human visual system that essentially has two main functional parts: the eye and the brain. In autonomous driving technologies, the eye may include a combination of multiple sensors, such as camera, radar, and lidar, while the brain may involve multiple artificial intelligence, machine learning and deep learning systems. The goal is to have full understanding of a dynamic, fast-moving environment in real time and human-like intelligence to act in response to changes in the environment.

In automated applications, such as self-driving vehicles, the radar and other sensors are expected to scan the environment of the vehicle with sufficient speed to enable instructions to the vehicle within a fast response time. Phased array antennas form a radiation pattern by combining signals from a number of antenna elements and controlling the phase and amplitude of each element. The antenna or radiating elements are arranged in an array or sub-arrays and typically include patches in a patch antenna configuration, a dipole, or a magnetic loop, among others. The relative phase between each radiating element can be fixed or adjusted by employing phase shifters coupled to each element. The direction of the beam generated by the antenna is controlled by changing the phase of the individual elements.

### BRIEF DESCRIPTION OF THE DRAWINGS

The present application may be fully appreciated in connection with the following detailed description taken in conjunction with the accompanying drawings, which are not drawn to scale and in which like reference characters refer to like parts throughout, and wherein:

FIG. 1 illustrates an example environment in which a beam steering radar in an autonomous vehicle is used to detect and identify objects, according to various implementations of the subject technology;

FIG. 2 illustrates a schematic diagram of an autonomous driving system for an ego vehicle in accordance with various implementations of the subject technology;

FIG. 3 illustrates an example network environment in which a radar system may be implemented in accordance with one or more implementations of the subject technology;

FIG. 4 illustrates a radar scanning system, according to various implementations of the subject technology;

FIG. 5 illustrates a hybrid radar scanning system, according to various implementations of the subject technology;

FIG. 6 illustrates a radar transceiver system for azimuth and elevation scanning, according to various implementations of the subject technology;

FIG. 7 illustrates a flow chart of an example process for operation of a radar scanning system as in FIG. 3, according to various implementations of the subject technology;

FIG. 8 illustrates a beam scan formation for a radar scanning system, according to various implementations of the subject technology; and

FIGS. 9 and 10 illustrate respective field of views for different scan operations of a radar system, according to various implementations of the subject technology.

### DETAILED DESCRIPTION

To scan a three-dimensional (3D) field of view from a moving vehicle, the subject technology includes a radar unit that incorporates multiple transceivers using fan beams. In combination, the transceivers of the radar unit can scan a 3D field of view with orthogonal fan beams that radiate at different frequencies. A first transceiver can scan by transmitting and receiving in the azimuth direction while a second transceiver can scan by transmitting and receiving in the elevation direction in some implementations, or each transceiver can scan the azimuth and elevation directions separately with a transmitter and a receiver of the transceiver in other implementations. In some examples, a first transceiver performing a first TX beam scanning operation utilizes an outgoing fan beam for scanning one axis (e.g., U-axis) to a target and the first transceiver performing a first RX beam scanning operation utilizes an incoming fan beam for scanning the same axis (e.g., U-axis) from the target at a same frequency as that of the first TX beam scanning operation. Similarly, a second transceiver performing a second TX beam scanning operation utilizes an outgoing fan beam for scanning the other axis (e.g., V-axis) to the target and the second transceiver performing a second RX beam scanning operation utilizes an incoming fan beam for scanning the same axis (e.g., V-axis) from the target at a same frequency as that of the second TX beam scanning operation, where the first transceiver and second transceiver radiate orthogonal fan beams at different frequencies.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology. In other instances, well-known methods and structures may not be described in detail to avoid unnecessarily obscuring the description of the examples. Also, the examples may be used in combination with each other.

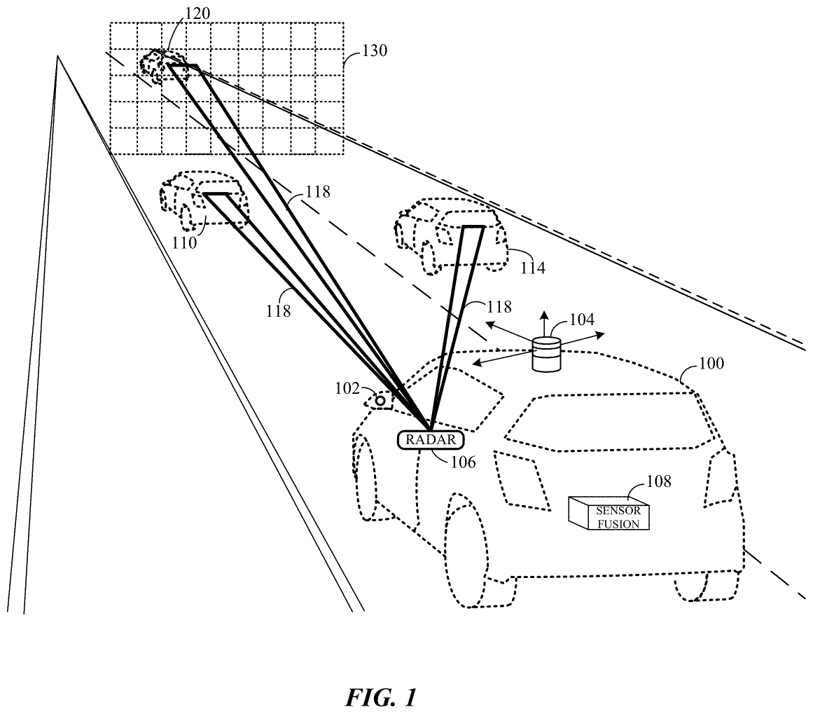

FIG. 1 illustrates an example environment in which a beam steering radar in an autonomous vehicle is used to detect and identify objects, according to various implementations of the subject technology. Ego vehicle 100 is an autonomous vehicle with a beam steering radar system 106 for transmitting a radar signal to scan a FoV or specific area. As described in more detail below, the radar signal is transmitted according to a set of scan parameters that can be adjusted to result in multiple transmission beams 118. The scan parameters may include, among others, the total angle of the scanned area defining the FoV, the beam width or the scan angle of each incremental transmission beam, the number of chirps in the radar signal, the chirp time, the chirp segment time, the chirp slope, and so on. The entire FoV or a portion of it can be scanned by a compilation of such transmission beams 118, which may be in successive adjacent scan positions or in a specific or random order. Note that the term FoV is used herein in reference to the radar transmissions and does not imply an optical FoV with unobstructed views. The scan parameters may also indicate the time interval between these incremental transmission beams, as well as start and stop angle positions for a full or partial scan.

In various examples, the ego vehicle 100 may also have other perception sensors, such as a camera 102 and a lidar 104. These perception sensors are not required for the ego vehicle 100 but may be useful in augmenting the object detection capabilities of the beam steering radar 106. The camera 102 may be used to detect visible objects and conditions and to assist in the performance of various functions. The lidar 104 can also be used to detect objects and provide this information to adjust control of the ego vehicle 100. This information may include information such as congestion on a highway, road conditions, and other conditions that would impact the sensors, actions or operations of the vehicle. Existing ADAS modules utilize camera sensors to assist drivers in driving functions such as parking (e.g., in rear view cameras). Cameras can capture texture, color and contrast information at a high level of detail, but similar to the human eye, they are susceptible to adverse weather conditions and variations in lighting. The camera 102 may have a high resolution but may not resolve objects beyond 50 meters.

Lidar sensors typically measure the distance to an object by calculating the time taken by a pulse of light to travel to an object and back to the sensor. When positioned on top of a vehicle, a lidar sensor can provide a 360° 3D view of the surrounding environment. Other approaches may use several lidars at different locations around the vehicle to provide the full 360° view. However, lidar sensors such as lidar 104 are still prohibitively expensive, bulky in size, sensitive to weather conditions and are limited to short ranges (e.g., less than 150-300 meters). Radars, on the other hand, have been used in vehicles for many years and operate in all-weather conditions. Radar sensors also use far less processing than the other types of sensors and have the advantage of detecting objects behind obstacles and determining the speed of moving objects. When it comes to resolution, the laser beams emitted by the lidar 104 are focused on small areas, have a smaller wavelength than RF signals, and can achieve around 0.25 degrees of resolution.

In various examples and as described in more detail below, the beam steering radar 106 can provide a 360° true 3D vision and human-like interpretation of the path and surrounding environment of the ego vehicle 100. The beam steering radar 106 is capable of shaping and steering RF beams in all directions in a 360° FoV with at least one beam steering antenna and recognize objects quickly and with a high degree of accuracy over a long range of around 300 meters or more. The short-range capabilities of the camera 102 and the lidar 104 along with the long-range capabilities of the radar 106 enable a sensor fusion module 108 in the ego vehicle 100 to enhance its object detection and identification.

As illustrated, the beam steering radar 106 can detect both vehicle 120 at a far range (e.g., greater than 350 m) as well as vehicles 110 and 114 at a short range (e.g., lesser than 100 m). Detecting both vehicles in a short amount of time and with enough range and velocity resolution is imperative for full autonomy of driving functions of the ego vehicle. The radar 106 has an adjustable Long-Range Radar (LRR) mode that enables the detection of long-range objects in a very short time to then focus on obtaining finer velocity resolution for the detected vehicles. Although not described herein, radar 106 is capable of time-alternatively reconfiguring between LRR and Short-Range Radar (SRR) modes. The SRR mode enables a wide beam with lower gain but can make quick decisions to avoid an accident, assist in parking and downtown travel, and capture information about a broad area of the environment. The LRR mode enables a narrow, directed beam and long distance, having high gain; this is powerful for high speed applications, and where longer processing time allows for greater reliability. Excessive dwell time for each beam position may cause blind zones, and the adjustable LRR mode ensures that fast object detection can occur at long range while maintaining the antenna gain, transmit power and desired Signal-to-Noise Ratio (SNR) for the radar operation.

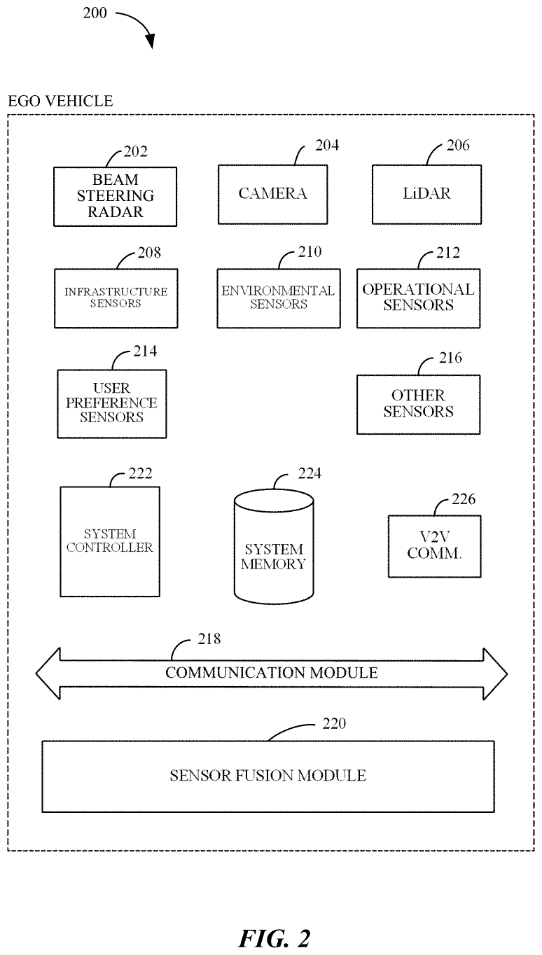

Attention is now directed to FIG. 2, which illustrates a schematic diagram of an autonomous driving system 200 for an ego vehicle in accordance with various implementations of the subject technology. The autonomous driving system 200 is a system for use in an ego vehicle that provides some or full automation of driving functions. The driving functions may include, for example, steering, accelerating, braking, and monitoring the surrounding environment and driving conditions to respond to events, such as changing lanes or speed when needed to avoid traffic, crossing pedestrians, animals, and so on. The autonomous driving system 200 includes a radar system 202 and other sensor systems such as camera 204, lidar 206, infrastructure sensors 208, environmental sensors 210, operational sensors 212, user preference sensors 214, and other sensors 216. The autonomous driving system 200 also includes a communications module 218, a sensor fusion module 220, a system controller 222, a system memory 224, and a Vehicle-to-Vehicle (V2V) communications module 226. It is appreciated that this configuration of the autonomous driving system 200 is an example configuration and not meant to be limiting to the specific structure illustrated in FIG. 2. Additional systems and modules not shown in FIG. 2 may be included in autonomous driving system 200.

In various examples, the beam steering radar 202 includes at least one beam steering antenna for providing dynamically controllable and steerable beams that can focus on one or multiple portions of a 260° FoV of the vehicle. The beams radiated from the beam steering antenna are reflected from objects in the vehicle's path and surrounding environment and received and processed by the radar 202 to detect and identify the objects. The radar 202 includes a perception module that is trained to detect and identify objects and control the radar module as desired. The camera 204 and lidar 206 may also be used to identify objects in the path and surrounding environment of the ego vehicle, albeit at a much lower range.

Infrastructure sensors 208 may provide information from infrastructure while driving, such as from a smart road configuration, billboard information, traffic alerts and indicators, including traffic lights, stop signs, traffic warnings, and so forth. This is a growing area, and the uses and capabilities derived from this information are immense. Environmental sensors 210 detect various conditions outside, such as temperature, humidity, fog, visibility, precipitation, among others. Operational sensors 212 provide information about the functional operation of the vehicle. This may be tire pressure, fuel levels, brake wear, and so forth. The user preference sensors 214 may detect conditions that are part of a user preference. This may be temperature adjustments, smart window shading, etc. Other sensors 216 may include additional sensors for monitoring conditions in and around the ego vehicle.

In various examples, the sensor fusion module 220 optimizes these various functions to provide an approximately comprehensive view of the ego vehicle and environments. Many types of sensors may be controlled by the sensor fusion module 220. These sensors may coordinate with each other to share information and consider the impact of one control action on another system. In one example, in a congested driving condition, a noise detection module (not shown) may identify that there are multiple radar signals that may interfere with the vehicle. This information may be used by a perception module in the radar 202 to adjust the scan parameters of the radar 202 to avoid these other signals and minimize interference.

In another example, environmental sensor 210 may detect that the weather is changing, and visibility is decreasing. In this situation, the sensor fusion module 220 may determine to configure the other sensors to improve the ability of the vehicle to navigate in these new conditions. The configuration may include turning off the camera 204 and/or the lidar 206 or reducing the sampling rate of these visibility-based sensors. This effectively places reliance on the sensor(s) adapted for the current situation. In response, the perception module configures the radar 202 for these conditions as well. For example, the radar 202 may reduce the beam width to provide a more focused beam, and thus a finer sensing capability.

In various examples, the sensor fusion module 220 may send a direct control to the radar 202 based on historical conditions and controls. The sensor fusion module 220 may also use some of the sensors within the autonomous driving system 200 to act as feedback or calibration for the other sensors. In this way, the operational sensor 212 may provide feedback to the perception module and/or to the sensor fusion module 220 to create templates, patterns and control scenarios. These are based on successful actions or may be based on poor results, where the sensor fusion module 220 learns from past actions.

Data from the sensors 202, 204, 206, 208, 210, 212, 214, 216 may be combined in the sensor fusion module 220 to improve the target detection and identification performance of autonomous driving system 200. The sensor fusion module 220 may itself be controlled by the system controller 222, which may also interact with and control other modules and systems in the ego vehicle. For example, the system controller 222 may power on or off the different sensors 202, 204, 206, 208, 210, 212, 214, 216 as desired, or provide instructions to the ego vehicle to stop upon identifying a driving hazard (e.g., deer, pedestrian, cyclist, or another vehicle suddenly appearing in the vehicle's path, flying debris, etc.)

All modules and systems in the autonomous driving system 200 communicate with each other through the communication module 218. The system memory 224 may store information and data (e.g., static and dynamic data) used for operation of the autonomous driving system 200 and the ego vehicle using the autonomous driving system 200. The V2V communications module 226 is used for communication with other vehicles. The V2V communications module 226 may also obtain information from other vehicles that is non-transparent to the user, driver, or rider of the ego vehicle, and may help vehicles coordinate with one another to avoid any type of collision.

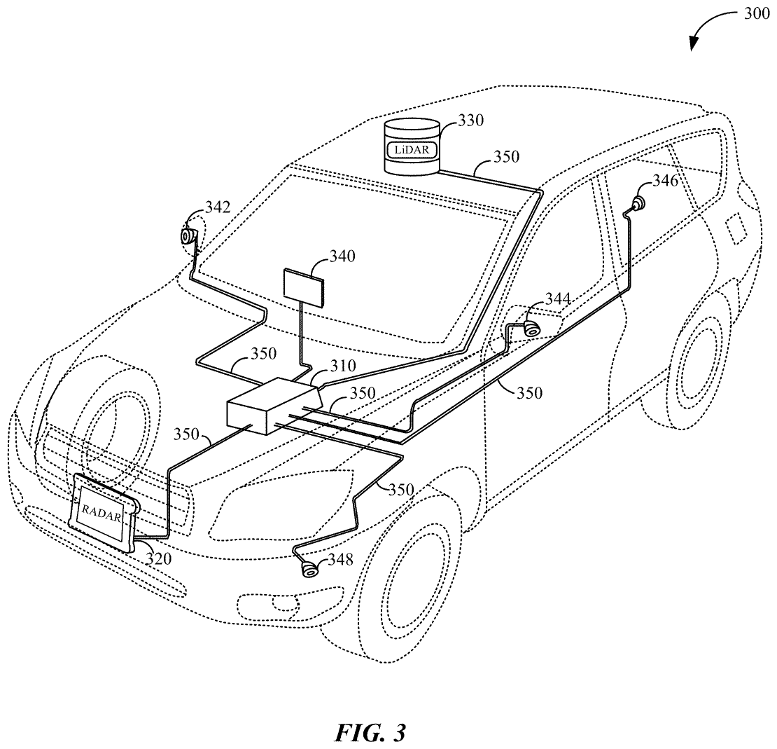

FIG. 3 illustrates an example network environment 300 in which a radar system may be implemented in accordance with one or more implementations of the subject technology. The example network environment 300 includes a number of electronic devices 320, 330, 340, 342, 344, 346, and 348 that are coupled to an electronic device 310 via the transmission lines 350. The electronic device 310 may communicably couple the electronic devices 342, 344, 346, 348 to one another. In one or more implementations, one or more of the electronic devices 342, 344, 346, 348 are communicatively coupled directly to one another, such as without the support of the electronic device 310. Not all of the depicted components may be required, however, and one or more implementations may include additional components not shown in the figure. Variations in the arrangement and type of the components may be made without departing from the scope of the claims as set forth herein. Additional components, different components, or fewer components may be provided.

In some implementations, one or more of the transmission lines 350 include wired transmission lines such as Ethernet transmission lines (e.g., 802.3) or wireless transmission lines such as WiFi (e.g., 802.11) or Bluetooth (e.g., 802.15). In this respect, the electronic devices 320, 330, 340, 342, 344, 346, 348 and 310 may implement a physical layer (PHY) that is interoperable with one or more aspects of one or more physical layer specifications, such as those described in the Institute of Electrical and Electronics Engineers (IEEE) 802.3 Standards (e.g., 802.3ch). The electronic device 310 may be, or may include, a switch device, a routing device, a hub device, or generally any device that may communicably couple the electronic devices 320, 330, 340, 342, 344, 346, and 348.

In one or more implementations, at least a portion of the example network environment 300 is implemented within a vehicle, such as a passenger car. For example, the electronic devices 342, 344, 346, 348 may include, or may be coupled to, various systems within a vehicle, such as a powertrain system, a chassis system, a telematics system, an entertainment system, a camera system, a sensor system, such as a lane departure system, a diagnostics system, or generally any system that may be used in a vehicle. In FIG. 3, the electronic device 310 is depicted as a central processing unit, the electronic device 320 is depicted as a radar system, the electronic device 330 is depicted as a lidar system, the electronic device 340 is depicted as an entertainment interface unit, and the electronic devices 342, 344, 346, 348 are depicted as camera devices, such as forward-view, rear-view and side-view cameras. In one or more implementations, the electronic device 310 and/or one or more of the electronic devices 342, 344, 346, 348 may be communicatively coupled to a public communication network, such as the Internet. In some implementations, the radar system 320 is, or includes at least a portion of, a license plate frame with two-dimensional beam scanning for automotive radar applications as will be discussed in more detail below.

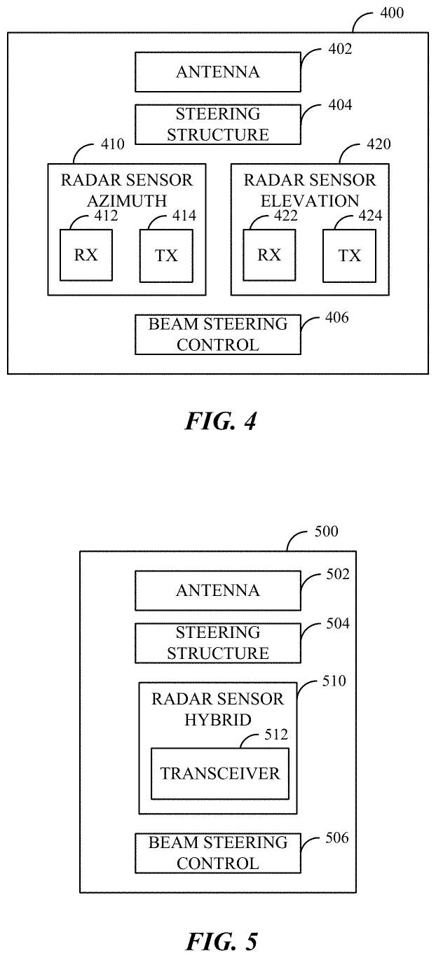

FIG. 4 illustrates a radar scanning system 400, according to various implementations of the subject technology. The radar scanning system 400 includes an antenna structure 402, a steering structure 404, a radar sensor azimuth module 410, a radar sensor elevation module 420, and a beam steering control module 406. Although the radar sensor azimuth module 410 and the radar sensor elevation module 420 are depicted as separate modules, the modules 410 and 420 may coexist in a same module in other implementations. Not all of the depicted components may be required, however, and one or more implementations may include additional components not shown in the figure. Variations in the arrangement and type of the components may be made without departing from the scope of the claims as set forth herein. Additional components, different components, or fewer components may be provided.

The beam steering control module 406 is coupled to the radar sensor azimuth module 410 and the radar sensor elevation module 420. The steering structure 404 is coupled to the antenna structure 402. In some implementations, the steering structure 404 includes phase shift elements that apply a phase shift to a radio frequency signal to or from the antenna structure 402. The beam steering control module 406 applies a control signal to the steering structure 404 to control the amount of phase shifting applied to outgoing radio frequency signals radiating by the antenna structure 402 (serving as beam steering) or the amount of phase shifting applied to incoming radio frequency return signals through the antenna structure 402 (serving as beam forming), for example. The radio frequency signal may be a Frequency-Modulated Continuous Waveform (FMCW) signal that enables extraction of range to an object and velocity of the object. The antenna structure 402 has a first portion of antenna elements for transmission and a second portion of antenna elements for receiving return signals. In some implementations, the antenna structure 402 is used for both transmission and receiving and is time division multiplexed. The radar sensor azimuth module 410 includes a receiver 412 and a transmitter 414 that are configured to operate in the azimuth direction. The radar sensor elevation module 420 includes a receiver 422 and a transmitter 424 that are configured to operate in the elevation direction. In some implementations, the transmitter 414 and the receiver 412 operate together in the same operational frequency to send and receive RF signals in the azimuth direction, and the transmitter 424 and the receiver 422 operate together in the same operational frequency (different from that of the transmitter 414 and the receiver 412) to send and receive RF signals in the elevation direction. This enables full scanning of a 3D field-of-view, where the elevation scan and the azimuth scan do not interfere with each other. In other implementations, the transmitter 414 and the receiver 422 operate together with orthogonal polarizations to send and receive RF signals in a first two-dimensional space, and the transmitter 424 and the receiver 412 operate together with orthogonal polarizations to send and receive RF signals in a second two-dimensional space.

FIG. 5 illustrates a hybrid radar scanning system 500, according to various implementations of the subject technology. The hybrid radar scanning system 500 includes an antenna structure 502, a steering structure 504, a radar sensor hybrid module 510 and a beam steering control module 506. Not all of the depicted components may be required, however, and one or more implementations may include additional components not shown in the figure. Variations in the arrangement and type of the components may be made without departing from the scope of the claims as set forth herein. Additional components, different components, or fewer components may be provided.

The radar sensor hybrid module 510 includes a transceiver 512. In some implementations, the transceiver 512 may include an analog beamforming portion and a digital beamforming portion. In some implementations, the steering structure 504 includes phase shift elements that apply a phase shift to a radio frequency signal to or from the antenna structure 502. The beam steering control module 506 applies a control signal to the steering structure 504 to control the amount of phase shifting applied to outgoing radio frequency signals radiating by the antenna structure 502 (serving as beam steering) or the amount of phase shifting applied to incoming radio frequency return signals through the antenna structure 502 (serving as beam forming), for example. The radar sensor hybrid module 510 may operate in both the azimuth and elevation directions with the transceiver 512. The transceiver 512 may include a transmitter and a receiver that operate in the same operational frequency (or with same polarization) in some implementations, or that operate in different operational frequencies (or with different polarizations) in other implementations.

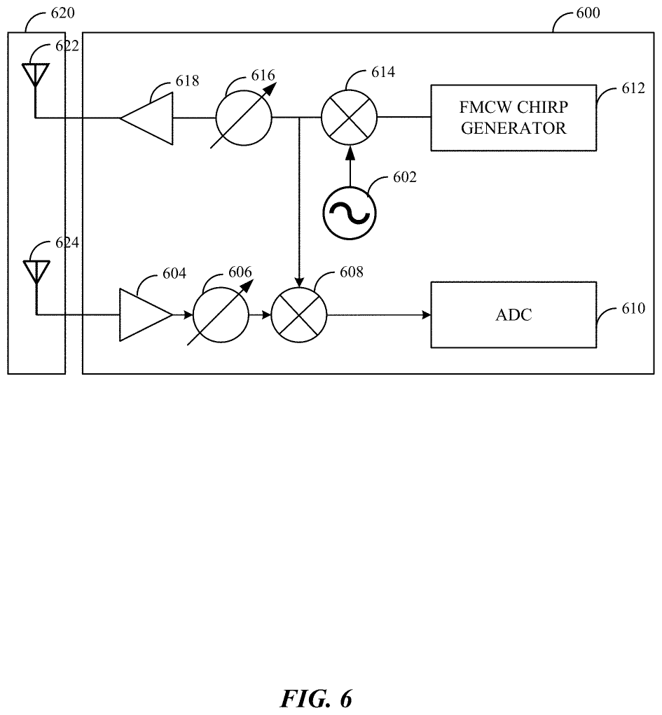

FIG. 6 illustrates a radar transceiver system 600 for azimuth and elevation scanning, according to various implementations of the subject technology. The radar transceiver system 600 includes a FMCW chirp generator 612, a mixer 614, a phase shifter 616 and a power amplifier 618 along a transmitter path of the radar transceiver system 600. The radar transceiver system 600 also includes an analog-to-digital converter (ADC) 610, a mixer 608, a phase shifter 606 and a low-noise amplifier 604 along a receiver path of the radar transceiver system 600. The radar transceiver system 600 is coupled to an antenna module 620. The antenna module 620 includes transmitter antenna 622 and receiver antenna 624. The radar transceiver system 600 also includes a local oscillator 602. In some aspects, the local oscillator 602 may be a voltage-controlled oscillator. Not all of the depicted components may be required, however, and one or more implementations may include additional components not shown in the figure. Variations in the arrangement and type of the components may be made without departing from the scope of the claims as set forth herein. Additional components, different components, or fewer components may be provided.

In the transmitter path, the FMCW chirp generator 612 is coupled to the mixer 614. The FMCW chirp generator 612 can generate a chirp signal. The chirp signal may be a frequency-modulated signal of a known stable frequency whose instantaneous frequency varies linearly over a fixed period of time (or sweep time) by a modulating signal. In some aspects, the operating frequencies are within a band of 76-81 GHz. The mixer 614 is coupled to the phase shifter 616. The mixer 614 is also coupled to the mixer 608 on the receive path to supply local oscillator signaling to the mixer 608. The phase shifter 616 is coupled to the power amplifier 618. The power amplifier 618 is coupled to the transmitter antenna 622 for transmission of the FCMW chirp signal generated by the FMCW chirp generator 612.

In the receiver path, a return RF signal is received by the receiver antenna 624 that is coupled to the low-noise amplifier 604. The low-noise amplifier 604 is coupled to the phase shifter 606. The phase shifter 606 is coupled to the mixer 608. The mixer 608 is coupled to the ADC 610. The ADC 610 can convert the return RF signal in the analog domain to the digital domain for receiver processing.

The local oscillator 602 is coupled to the mixer 614. The local oscillator 602 can generate local oscillator signals to send to the mixer 614. The mixer 614 can supply local oscillator signaling to the mixer 608. In the transmitter path, the mixer 614 can up-convert the chirp signal to a higher frequency, such as millimeter-wave radio frequencies, using the local oscillator signals from the local oscillator 602. In the receiver path, the mixer 608 can down-convert the return RF signal at a millimeter-wave radio frequency to a lower frequency, such as an intermediate frequency (IF), using local oscillator signaling received via the mixer 614. In other implementations, the mixer 614 and the mixer 608 may be coupled to the local oscillator 602 along separate signal paths.

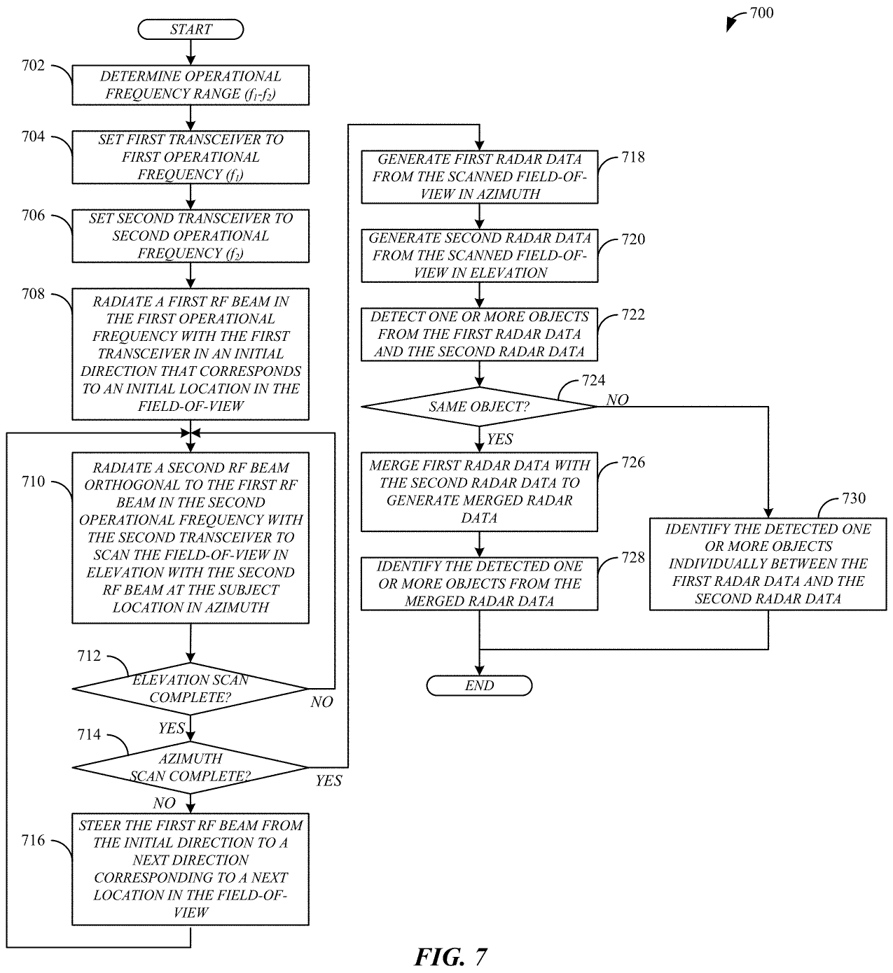

FIG. 7 illustrates a flow chart of an example process 700 for operation of a radar scanning system as in FIG. 6, according to various implementations of the subject technology. For explanatory purposes, the example process 700 is primarily described herein with reference to FIGS. 4 and 5; however, the example process 700 is not limited to the radar scanning system 400 of FIG. 4, and the example process 700 can be performed by one or more other components of the radar scanning system 400 of FIG. 4, such as, for example, the radar sensor azimuth module 410, the radar sensor elevation module 420, and the beam steering control module 406 of FIG. 4. Further for explanatory purposes, the blocks of the example process 700 are described herein as occurring in serial, or linearly. However, multiple blocks of the example process 700 can occur in parallel. In addition, the blocks of the example process 700 can be performed in a different order than the order shown and/or one or more of the blocks of the example process 700 are not performed.

The process 700 begins at step 702, where an operational frequency range including frequencies f₁ and f₂ is determined. Next, at step 704, a first transceiver is set to a first operational frequency f₁. Subsequently, at step 706, a second transceiver is set to a second operational frequency f₂ that is different from the first operational frequency.

Next, at step 708, a first RF beam is radiated in the first operational frequency with the first transceiver in an initial direction that corresponds to an initial location in the field-of-view. Subsequently, at step 710, a second RF beam is radiated orthogonal to the first RF beam in the second operational frequency with the second transceiver to scan the field-of-view in elevation with the second RF beam at the subject location in azimuth.

Next, at step 712, a determination is made as to whether the elevation scan at the subject location in azimuth is complete. If the elevation scan is complete, then the process 700 proceeds to step 714. Otherwise, the process 700 proceeds back to step 710. Subsequently, at step 714, another determination is made as to whether the azimuth scan across the field-of-view is complete. If the azimuth scan is complete, then the process 700 proceeds to step 718. Otherwise, the process 700 proceeds to step 716.

At step 716, the first RF beam is steered from the initial direction to a next direction that corresponds to a next location in the field-of-view in the azimuth direction. For example, the amount of steering may correspond to a predetermined phase shift step size. At the conclusion of step 716, the process 700 proceeds back to step 710 to perform the elevation scan at the new azimuth location.

At step 718, when the azimuth scan is complete, first radar data is generated from the scanned field-of-view in azimuth. Subsequently, at step 720, second radar data is generated from the scanned field-of-view in elevation.

Next, at step 722, one or more objects can be detected from the first radar data and the second radar data. From these scans, the process 700 can detect objects in the 3D field-of-view. Subsequently, at step 714, a determination is made as to whether the azimuth and elevation scans detected the same object. If the azimuth and elevation scans identify a same object at a same location, then the process 700 proceeds to step 726. Otherwise, the process 700 proceeds to step 730. At step 726, the first radar data and the second radar data are merged to generated merged radar data. Next, at step 728, a further detection can be performed to identify the detected one or more objects from the merged radar data. At step 730, the process 700 proceeds with identifying the detected one or more objects individually between the first radar data and the second radar data. In this respect, the detected objects are distinct objects located at different locations in azimuth and elevation. At the conclusion of steps 728 or 730, the process 700 terminates.

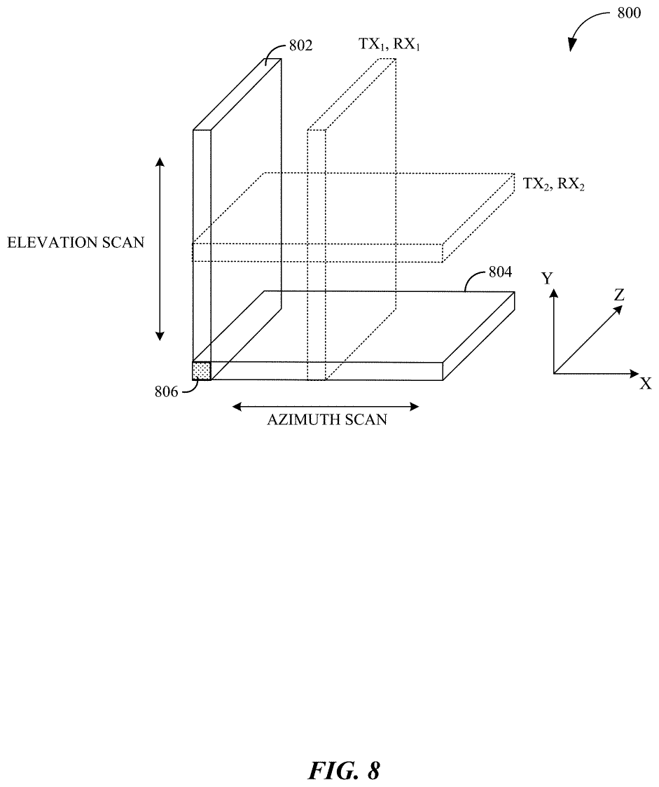

FIG. 8 illustrate beam scan formations for a radar scanning system, according to various implementations of the subject technology. In FIG. 8, a scanning environment 800 includes an y-z plane beam 802 for scanning the azimuth direction and a x-z plane beam 804 for scanning the elevation direction. In some aspects, the y-z plane is the azimuth plane, and the x-z plane is the elevation plane. The scanning environment 800 depicts the scanning movement of the y-z plane beam 802 in the azimuth direction, x. Similarly, the scanning environment 800 depicts the scanning movement of the x-z plane beam 804 in the elevation direction, y. The y-z plane beam 802 alone can provide azimuth information with the exclusion of elevation information. Similarly, the x-z plane beam 804 alone can provide elevation information with the exclusion of azimuth information. At the intersection 806 of the y-z plane beam 802 and the x-z plane beam 804, both azimuth and elevation information can be determined. In some implementations, a first transmitter (depicted as “TX₁”) is paired with a first receiver (depicted as “RX₁”) to send and receive RF signaling at a same frequency, and a second transmitter (depicted as “TX₂”) is paired with a second receiver (depicted as “RX₂”) to send and receive RF signaling at a same frequency that is different from that of the first transmitter and first receiver.

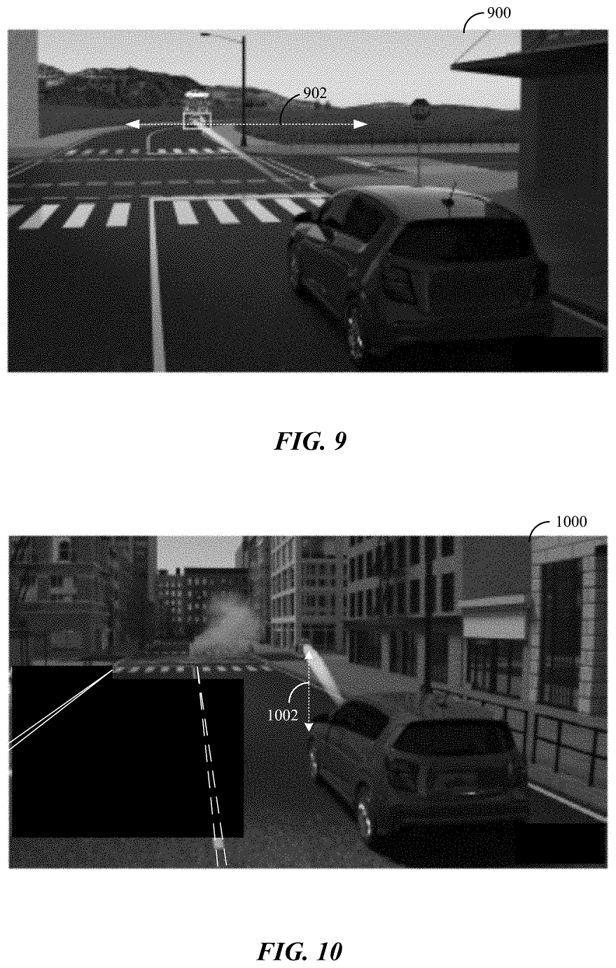

FIGS. 9 and 10 illustrate radar scan environments with respective field of views for different scan operations of a radar system, according to various implementations of the subject technology. In FIG. 9, a radar scan environment 900 depicts a moving vehicle with the radar system operating a radar scan in azimuth direction 902 (referred hereto as an “azimuth scan”). In FIG. 10, a radar scan environment 1000 depicts a moving vehicle with the radar system operating a radar scan in elevation direction 1002 (referred hereto as an “elevation scan”). Each scan is operational by the radar system at a different frequency within a specified operational frequency band. In some implementations, an alternate radar system applies a same frequency at each of multiple transceivers, while positioning them in different directions.

It is also appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item).The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A radar system for three-dimensional beam scanning, comprising:
an antenna module configured to radiate one or more radio frequency (RF) beams with an analog beamforming antenna in a plurality of directions using one or more phase control elements and to generate radar data capturing a surrounding environment from one or more received RF return signals, wherein the antenna module comprises:
a first transceiver operational at a first frequency and configured to scan a field of view with first RF beams along a first axis, and
a second transceiver operational at a second frequency different from the first frequency and configured to scan the field of view with second RF beams along a second axis orthogonal to the first axis; and
a perception module configured to detect and identify a target in the surrounding environment from the radar data.

2. The radar system of claim 1, wherein the first transceiver is further configured to scan the field of view along the first axis concurrently with the second transceiver scanning the field of view along the second axis.

3. The radar system of claim 1, wherein the first transceiver is further configured to scan a subject location in azimuth while the second transceiver scans the field-of-view in elevation at the subject location in azimuth.

4. The radar system of claim 3, wherein the first transceiver is further configured to steer the first RF beams to a subsequent location in azimuth when the second transceiver completes scanning the field-of-view in elevation at the subject location in azimuth.

5. The radar system of claim 1, wherein the antenna module is further configured to generate first radar data from the one or more received RF return signals in the first axis and second radar data from the one or more received RF return signals in the second axis.

6. The radar system of claim 5, wherein the perception module is further configured to:
detect one or more objects from the first radar data and the second radar data;
determine whether at least one of the detected one or more objects is a same object between the first radar data and the second radar data; and
merge the first radar data with the second radar data to generate merged radar data when the at least one of the detected one or more objects is the same object.

7. The radar system of claim 6, wherein the perception module is further configured to identify the detected one or more objects individually between the first radar data and the second radar data when the at least one of the detected one or more objects is not the same object.

8. The radar system of claim 1, wherein the first axis corresponds to an azimuth direction and the second axis corresponds to an elevation direction.

9. The radar system of claim 1, wherein each of the first RF beams and the second RF beams comprises a frequency-modulated continuous waveform (FMCW) chirp signal.
